(19) United States
(12) Patent Application Publication
(10) Pub. No.: US 2008/0109222 A1
(43) Pub. Date: May 8, 2008

(54) Advertising using extracted context sensitive information and data of interest from voice/audio transmissions and recordings

(76) Inventor: Edward Liu, Palo Alto, CA (US)

Correspondence Address: Edward Liu, 726 Homer Avenue, Palo Alto, CA, 94301, US

(21) Appl. No.: 11/592,676

(22) Filed: Nov. 4, 2006

(51) Int. Cl. G10L 15/00; G06Q 30/00

(52) U.S. Cl. 704/246; 705/14; 705/10; 704/E15.001

(57) ABSTRACT

Method and apparatus that use voice/audio recognition and analysis technologies to deliver assigned context sensitive information and data of interest (keywords, phrases, mood, etc.). Context sensitive information and data of interest can be extracted from any voice/audio transmissions and voice/audio recordings (or any transmission or recording that includes voice/audio) for advertising purposes. This invention includes the said assigned context sensitive information and data of interest extraction method using voice/audio recognition and analysis technologies. Most importantly, this invention opens up new doors to advertising using extracted context sensitive information and data of interest from voice/audio transmissions and recordings (or any transmission that includes voice/audio).

### REFERENCE CITED

### 6332120 December 2001 Warren

### 7103563 September 2006 Voisin, et al.

### 6999431 February 2006 Rines

### 6977997 December 2005 Shioda, et al.

### 6493437 December 2002 Olshansky

### BACKGROUND OF THE INVENTION

1. Field of the Invention

The present invention relates generally to a new method and apparatus for extracting and delivering context sensitive information. More specifically it relates to a method and apparatus using voice/audio recognition and analysis technologies to automatically monitor any voice/audio transmissions and recordings that could take place (including but not limited to): VoIP, internet voice calls, voice conferences, over the internet, land line phone calls, person to person conversation, etc. to extract and deliver assigned context sensitive information and data of interest (including but not limited to keywords, phrases, moods, etc.) for advertising purposes.

Information and data from consumers are the most important sources for the directions of all businesses. The more a business or organization knows about their consumers' preferences, the better they can mold their business or organization to provide exactly what the consumers needs. The traditional way of gathering information is usually surveying, watching the market trend, extracting visual information from the internet—basically picking up passive hints that the market can give off, etc. Basically all these information are gathered from surveying efforts or other forms of visual information extraction. Unfortunately, the world is missing out the biggest source of valuable information and data—voice/audio transmissions and recordings, where voice/audio transmissions and recordings are the most common form of communication in this world. Furthermore, as they are the most common way of communication, it is understandable that it is easiest to gather information from them.

Common ways of voice/audio transmission and recording include but not limited to analog land line phone calls, internet voice transmission technologies/programs/software (e.g. Skype, Gizmo, Gtalk, etc.), VoIP phones, podcasts, voice conferences, person to person conversation, voice recordings, etc. All of these modes of communications can be used to extract and deliver valuable context sensitive information of interest for advertising. While analog phone call conversations and person to person conversations provide valuable information, it is harder to utilize such transmissions as the system and interface behind such transmissions are not immediately set up to deliver advertisements. However, it is not impossible to do so, so this invention can also be utilized on the transmission forms (analog voice data transmissions) prior mentioned. On the other hand, the internet, digital voice transmission technologies, and other flexible forms of integrate-able systems are easier to apply this invention on. Most importantly, the trend is slowly moving towards using the digital internet line as the voice/audio transmission medium. These digital internet voice/audio transmissions are based on technologies such as VoIP (Voice Over Internet Protocol), and such technologies provide advantages over traditional land line such as opening up doors for cheaper voice conversations, consolidated services, related enhancement services, advertisements, etc. These technologies also often provide a visual interface for you to use the service on, which more readily allows opportunities for advertisements. As the digital transmission technologies are mainly built using the internet, it is important to understand the background behind the internet and being “online.”

In recent years, many ideas, products, and services have gone online. Internet has become one of the main venues to search for things, get help, shop, advertise, chat, talk, etc. It has also become one of the main venues to extract valuable context sensitive information from consumers for businesses or organizations that are there to tend to the consumers' needs. This information is used to understand the preferences of each individual so that the businesses and organizations using this information can better provide them with the needs the consumers have in life. This information is currently only acquired from the visual form of information—text, pictures, etc on the internet. This market is already saturated, and is quietly demanding a new source of information. People have to talk anyways, why not help them by extracting what they need and bettering their lives with it?

Hence, it is mandatory to provide a system and method to provide consumers with a new way to help them express themselves without any extra effort. Most importantly, it will increase the satisfaction of consumers and help businesses and organizations grow. Also, it is desirable for all businesses and organizations to be able to use this apparatus and method to acquire valuable information from the core of their businesses and organizations—their customers, the people, everyone.

2. Description of the Related Art

The general purpose of the present invention, which will be described subsequently in greater detail, is to provide new ways of extracting context sensitive information and data of interest using voice/audio recognition and analysis technologies and then delivering the extracted results for advertising purposes. Even though this invention focuses on the result of advertising, it has unlimited advantages and possibilities. This invention introduces many novel features that result in new ways of using the extracted and delivered information and data which are not anticipated, rendered obvious, suggested, or even implied by any of the prior art voice analysis information, either alone or in any combination thereof.

It can be appreciated that services using voice/audio recognition and analysis have been in use for years. Systems that use voice recognition technologies are also widely adopted by businesses and organizations that use automated systems to lower labor cost and to increase customers' satisfaction with easy and automated operations. These businesses and organizations include but not limited to banks, stores, electronic commerce stores, service providers, etc. However, such systems using voice recognition are usually set up so that it can only accept a limited amount of commands. It is also only set up so that the user can more easily navigate through the selection process during the automated calls.

A similar example is a method and apparatus that uses a similar method to monitor information of interest for PR efforts (please refer to U.S. Pat. No. 6,332,120). What the method and apparatus does is using a very similar procedure as the present invention, but the final result of the similar method is generating a report by analyzing the context around the information of interest found in a broadcast (radios, news, TV, commercials, etc.). That method was invented to more easily enable PR experts to analyze what kind of audio program is being broadcasted. The procedures are very similar to the present invention, but they do not address the significance of using such method to contribute to the advertising world.

As another example that relates to this invention (please refer to U.S. Pat. No. 7,103,563), there is a system that incorporates voice recognition technologies that answer to a caller's inquiry of a service or product and then replying it with an advertisement. Unfortunately, this system is only utilized with consumers' conscious effort in requesting specific information. Furthermore, such technologies can only reply audio advertisements during and on the conversation, even if the system uses the internet as its portal for receiving the call and as the source of receiving the advertisements to provide to the caller. This system is not efficient, and requires the caller to stay on the phone for the duration of the time. Also, the population that uses such service is very limited.

In light of another similar service, Pluggd.com is a company that uses voice recognition technology to help their users search for audio or video files. The service basically lets the user assign keywords or phrases that they would like to search for in audio and video files. When a keyword if found in a video or audio file, the audio or video file would show up, and would specify where it appears in the file stream. This invention also has similar procedures as the present invention and U.S. Pat. No. 6,332,120 mentioned above, but Pluggd.com still does not address the importance of advertising.

Voice/audio analysis and recognition are also utilized for many other usages, but they are missing one big gap in the market. They are missing the gap of using the technology to extract and deliver context sensitive information and data of interest from analyzing voice/audio transmissions and recordings, and then using the resulting information for advertising.

Speaking of advertisement and online services market, the main problem with a lot of internet advertising companies like Google, MSN, and Yahoo! is that they are only structured to utilize extracted visual and hand typed information (keywords and phrases) for advertising, which includes but not limited to building consumer portfolios, services, products, etc. Moreover, they focus on the visual and hand-typed extracting and delivering of information and data (keywords and phrases) on websites and etc., leaving out the spoken aspect of extracting and delivering information. Talking, voice/audio transmissions in general, is just as essential as breathing and being alive, so being able to extract and deliver such information of interest (keywords, phrases, moods, etc.) will be greatly beneficial for the society and increasing the satisfaction of people.

In these respects, the usage of voice/audio analysis and recognition technologies to extract and deliver context sensitive information and data of interest (keywords, phrases, moods, etc.) according to the present invention substantially departs from the conventional concepts and designs of prior arts, and in doing so provides an apparatus and method developed for the monumental enhancement of advertising purposes.

### SUMMARY OF THE INVENTION

This and other objects of the present invention are accomplished by providing an apparatus and method that uses voice/audio recognition and analysis technologies as a medium. The apparatus and method allows the user (including but not limited to any user, business, organization, etc.) to assign or input context sensitive information or data of interest that they want the medium to look for. The medium, which is the voice/audio recognition and analysis technology, will automatically monitor and analyze any voice/audio transmission or recording for the said context sensitive information of interest. If the medium finds the assigned context sensitive information and data of interest in the voice/audio transmission, voice/audio recording, or any transmission or recording that includes voice/audio, the apparatus and method will deliver the said extracted context sensitive information and data of interest for advertising purposes. There is no limit to the destinations that the extracted context sensitive information and data can be delivered to as this invention serves to be the bridge of unlimited possibilities between voice/audio transmissions and recordings with businesses/organizations that want to provide better ways to serve their consumers. There is also no limit to the forms that the extract context sensitive information and data can be delivered in. The present invention, the apparatus or method, will require the medium to deliver the extracted context sensitive information and data of interest.

In this respect, before explaining any embodiments of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

In the market for advertisements, an embodiment of the present invention provides a method and apparatus for businesses and organizations to gain new ways of receiving context sensitive information of interest from consumers to better provide more individually tailored advertisements for consumers. The business or organization first input and assign context sensitive information that they want to trigger their advertisements. If the voice/audio transmission or recording is found with the said assigned context sensitive information, the appropriate businesses' or organizations' advertisements will be triggered and delivered from the advertiser (including but not limited to advertising portals and other advertising related services) to the consumer through the portal or interface that the consumer is using for the transmission or recording. Examples of transmission networks and portals are (including but not limited to): VoIP phones, PC VoIP voice portals (Skype, Gizmo Project, Google Talk, MSN Messenger, etc.), land line phone calls, cell phone calls, video conferencing, etc.

In another embodiment of the present invention provides a method and apparatus for businesses and organizations to gain new ways to display advertisements without irritating consumers. One example is related to advertisements on radios. Radio advertisements are set up to play advertisements after and in between shows, and some commercials are often irrelevant and lengthy, which cause irritation for the audience. This invention provides a new way for radios to deliver advertisements to the audience without irritating the audience. By using this system and apparatus that this invention provides, this invention opens up doors for advertisers (including but not limited to users, businesses, and organizations, etc.) to deliver their advertisements through mediums other than the radio itself. This invention could be structured and integrated to send advertisements onto a car's dashboard, a stereo's LCD screen, a computer's screen, etc. where the advertisements delivered would be related to the context sensitive information or data of interest extracted from the radio or transmission session. This creates a method for commercial-free radio shows and also being able to deliver content related advertisements.

This invention can also provide an enhancement for businesses or organizations that use automated systems. An embodiment related to automated systems of the present invention provides a method for service providers to provide better services to consumers and their customers. During a consumer's voice/audio transmission with an automated portal, this invention can also be applied. During the consumer's interaction with the automated service portal, the voice data recognition and analysis technology will be set up by the business or organization to pick up certain context sensitive information or data (keywords, phrases, how loud, choice of words, etc.). The acquired information and data will then help the business or organization understand how each consumer's mood is and more effectively service them when the consumer reaches a customer support representative.

There has thus been outlined, rather broadly, the more important features and embodiments of the invention in order that the detailed description thereof may be better understood, and in order that the present contribution to the art may be better appreciated. There are additional features of the invention that will be described hereinafter.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

The invention is illustrated by way of example and not limited to the figures attached. Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram of the general representation of this invention;

FIG. 2 is a block diagram of the general representation of an apparatus of this invention;

### DETAILED DESCRIPTION OF THE INVENTION

Turning now descriptively to the drawings, in which similar reference characters denote similar elements throughout the several views, the attached figures illustrate general representations of using voice/audio analysis and recognition technologies to extract and deliver context sensitive information and data of interest from any kind of voice/audio transmissions or voice/audio recordings. The information is furthermore used for advertising purposes or applications related to advertising.

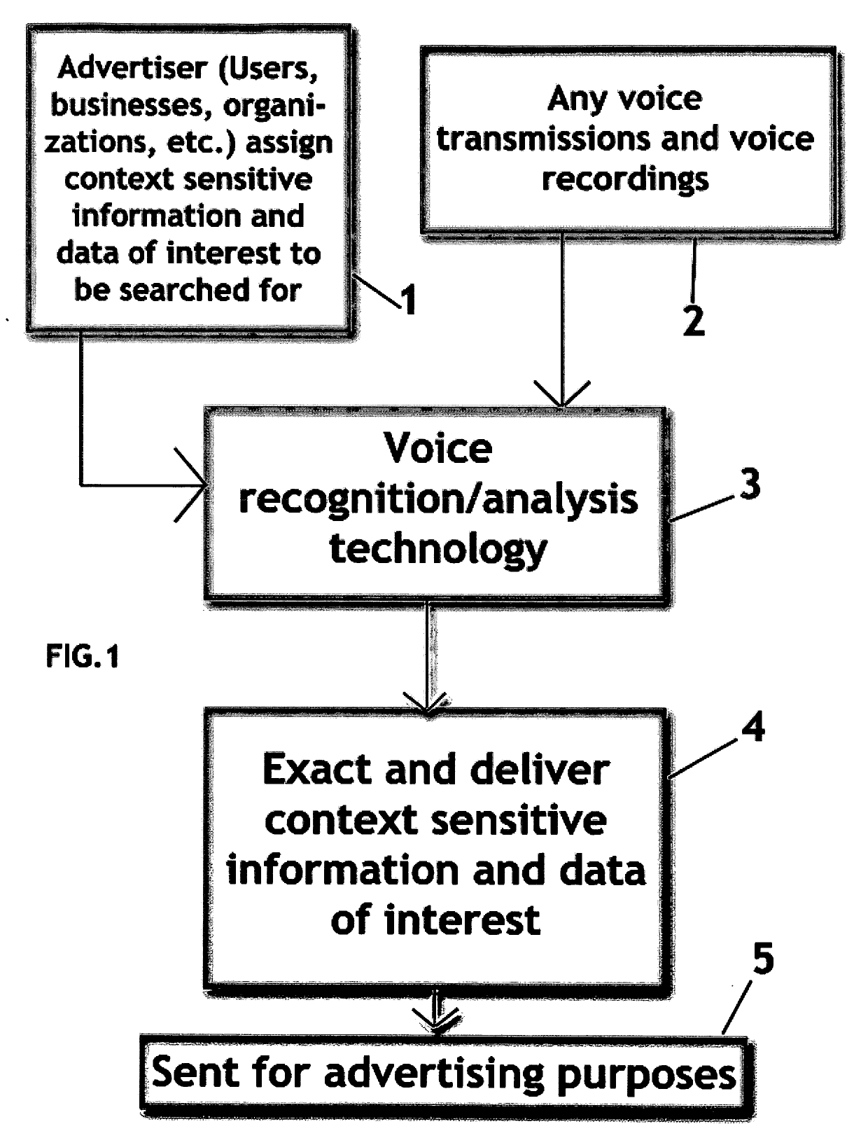

As an example, say PC based VoIP service provider Skype wants to start utilizing the physical visual space on their software interface that can be great advertising spots for advertisers. So Skype can implement the present invention into their system, and start providing advertisements to their users. Looking at FIG. 1, which is a simple and general representation of the present invention, it depicts a scenario of live transmissions like this:
1. Skype connects with Google to make use of Google's Adwords (1: Advertisers choose the context sensitive keywords, phrases, etc. they want to trigger their advertisements) and Adsense (A Google service where any interface can use to display advertisements from Google Adwords) services.
2. While users are having a video/audio conversation (2), Skype uses the method of present invention (3: uses voice/audio recognition) to look for the information of interest (keywords and phrases) that Google Adwords feeds it.
3. The present invention that is implemented into Skype's system will extract and send results back to Google Adwords if keywords or phrases of interest are found (4), which will trigger corresponding advertisements that are assigned to the said keywords or phrases from Google Adwords.
4. Google Adwords will then send the advertisement onto the spot where Skype designates the Adsense advertisements to show up (5).

As another example, in light of voice/audio files and including but not limited to video files with voice/audio transmission in them, this invention can also be fully utilized (Please also refer to FIG. 1):
1. A website like Youtube that streams files with audio and voice associated with them (2) can be connected to Google Adwords and Google Adsense (1) for delivering advertisements onto their webpage for their audience.
2. On a typical page of Youtube, there are a lot of video files that include audio and voice transmission (2). Using the present invention, Youtube can integrate this invention onto their system.
3. This invention which is attached to Youtube will analyze each video/audio stream for context sensitive information or data of interest (3) that it receives from Google Adwords (1).
4. Once the information of interest is found, this invention will send the information back to Google Adwords (4) so that the corresponding advertisements can be sent back to Youtube's webpage (5).
5. The advertisements sent back will show up at the spots on the webpage where Youtube designates Google Adsense to be located at (5).

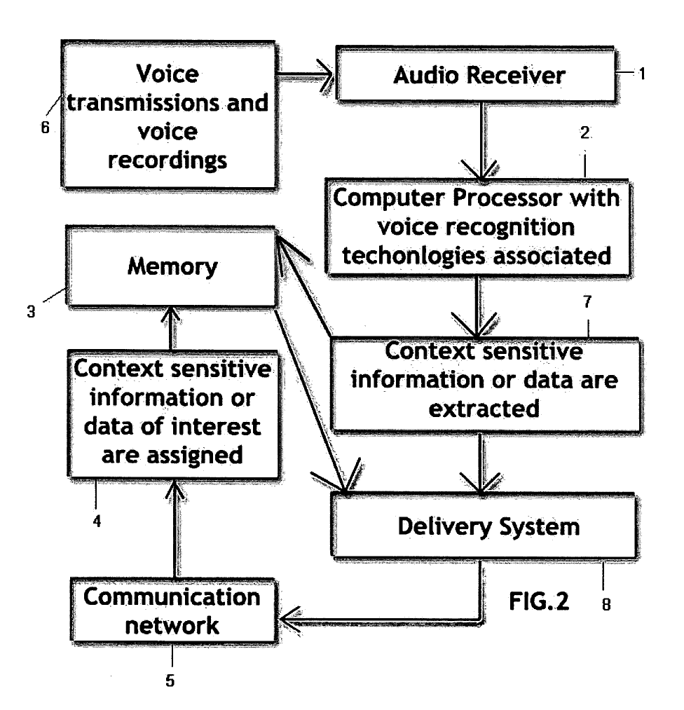

As another example, drivers can now enjoy commercial free radio broadcasts on their car using the present invention. Referring to FIG. 2, there can be a module that could make this work:
1. The apparatus in FIG. 2 is connected with the radio wherein the audio receiver (1) receives voice/audio transmission from the radio.
2. The memory (3) in the apparatus is directly connected to a communication network (5), and is fed with advertiser-assigned context sensitive information or data of interest (4) to be extracted from the radio broadcast to trigger advertisements.
3. Voice recognition technology is associated with the computer processor (2) such that the computer processor will process and extract the radio/voice/audio transmission (6) for the context sensitive information or data of interest that the advertisers are looking for.
4. The found results (7, 8) are either sent out back into the communication network (5) to fetch the corresponding advertisements, or it can store it into the memory. For example, results can be sent to an advertising portal like Google Adwords so that Google Adwords can respond with an advertisement.
5. The corresponding advertisement is then delivered to the vehicle through method including but not limited to visual displays, memory, audio, etc.

There are different levels of implementations of the present invention. The present invention allows implementation from the very basic, to more complicated structures. Therefore, it should be appreciated that many other implementations can be provided with more advanced structuring.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method for monitoring voice/audio transmissions and voice/audio recordings or any transmission/recording that includes voice/audio to extract and deliver context sensitive information or data of interest for means of advertising comprising the steps of:
Advertiser (including but not limited to individuals, businesses, organizations, etc.) assigning context sensitive information or data of interest (including but not limited to: keywords, moods, phrases, etc.)
Automatically monitoring any said voice/audio transmission or voice/audio recording or any transmission/recording that includes voice/audio for the said assigned context sensitive information or data of interest using voice recognition and voice analysis technologies.
Processing the said monitored voice/audio transmission or voice/audio recording or any transmission/recording that includes voice/audio for the said assigned context sensitive information or data of interest using voice recognition and voice analysis technologies.
Context sensitive information or data of interest (results) found and extracted are delivered for advertising purposes. The delivery destination includes but not limited to sending back to the advertiser or a destination that the advertiser assigns. There is also no limit to what form the extracted context sensitive information or data of interest can be delivered in.

2. A method in accordance to claim 1 comprising the further steps of said advertiser, advertising portal, or destination receiving the delivered results and responding with a corresponding and specifically assigned advertisement.

3. A method in accordance to claim 1 comprising the further steps of said advertiser, advertising portal, or destination receiving the delivered results sending the results elsewhere for further advertising instructions.

4. A method in accordance to claim 1 comprising the further steps of storing the extracted context sensitive information or data of interest (results) into a database.

5. A method in accordance to claim 4 comprising the further steps of counting and organizing the frequency/weight of an extracted context sensitive information or data of interest (results) in the database.

6. A method in accordance to claim 5 comprising the further steps of ranking the extracted context sensitive information or data of interest (results) by the number of times (frequency and weight) that they are found.

7. A method in accordance to claim 1 comprising the further steps of extracting and storing the context around the extracted context sensitive information or data of interest (results) into a database for advertising research purposes.

8. A method in accordance to claim 1 comprising the further steps of determining and reporting the source, length, location, type, and timestamp of the voice/audio transmission or voice/audio recording.

9. A method in accordance to claim 1 comprising the further steps of determining a specific reaction for a specific said context sensitive information or data of interest (results) extracted and delivered.

10. Apparatus for monitoring voice/audio transmissions and voice/audio recordings or any transmission or recording that includes voice/audio to extract and deliver context sensitive information or data of interest for means of advertising comprising:
A computer processor.
A memory associated with said computer processor for storing the assigned context sensitive information or data of interest from advertisers (including but not limited to individuals, businesses, organizations, etc.).
A communication network where the user can communicate with the memory for means of assigning context sensitive information or data of interest or acquiring information or data from it.
An audio receiver to monitor any voice/audio transmissions or voice/audio recordings.
A voice/audio recognition or voice/audio analysis system associated with audio receiver and said computer processor for detecting the said assigned context sensitive information or data of interest in the monitored voice transmission or voice recording.
A delivery system associated with said computer processor and said communication network that sends out the result of the extracted assigned context sensitive information or data of interest (results) for advertising purposes. The delivery destination includes but not limited to sending back to the advertiser or a destination that the advertiser assigns. There is also no limit to what form the extracted context sensitive information or data of interest can be delivered in.

11. Apparatus in accordance to claim 10 wherein said delivery system delivers extracted results to said advertiser, advertising portal, or destination. Said advertiser, advertising portal, or destination will then respond with a corresponding and specifically assigned advertisement.

12. A method in accordance to claim 10 wherein the said advertiser, advertising portal, or destination receiving the delivered results sending the results elsewhere for further advertising instructions.

13. Apparatus in accordance with claim 10 wherein the said delivery system is located remotely and communicates with the said computer processor, said memory, said audio receiver using a communication network.

14. Apparatus in accordance with claim 10 wherein extracted context sensitive information or data of interest (results) are stored into a database in said memory.

15. Apparatus in accordance with claim 14 wherein said computer processor counts and organizes the frequency/weight of the extracted context sensitive information or data or interest (results) in the database.

16. Apparatus in accordance with claim 14 wherein said computer processor ranks the extracted context sensitive information or data of interest (results) by their weight and frequency.

17. Apparatus in accordance to claim 10 wherein the context around the extracted context sensitive information or data of interest (results) is stored into said memory for advertising research purposes.

18. Apparatus in accordance to claim 10 wherein said computer processor determines and reports the source, length, location, type, and timestamp of the said received voice/audio transmission or voice recording.

19. Apparatus in accordance to claim 10 wherein said computer processor is set up to reply a specific reaction for a specific said context sensitive information or data of interest (results) extracted by said voice/audio recognition technology.
